(19) United States
(12) Patent Application Publication
(10) Pub. No.: US 2014/0081660 A1
(43) Pub. Date: Mar. 20, 2014

(54) Paperless Radiology Workflow

(71) Applicants: Saida Jahir Gizi Hasanova, Bloomington, MN (US); Nuri Hasanov, Coon Rapids, MN (US)

(72) Inventors: Saida Jahir Gizi Hasanova, Bloomington, MN (US); Nuri Hasanov, Coon Rapids, MN (US)

(21) Appl. No.: 13/856,385

(22) Filed: Apr. 3, 2013

Related U.S. Application Data
(60) Provisional application No. 61/764,653, filed on Feb. 14, 2013.

(51) Int. Cl. G06F 19/00

(52) U.S. Cl. CPC G06F 19/321
USPC 705/3

(57) ABSTRACT

Technical advances over the past few years have rapidly increased the possibilities for filmless radiology services provided by picture archiving and communication systems (PACS). PACS is technology to eliminate film from radiology tests in the same way a desktop scanner is technology to eliminate paper in the radiology department. Paperless workflow will allow the radiology department to reduce medical errors, to improve access to critical information, to promote dynamic workload balancing across the department, to support decentralization, and to decrease interruptions. To move from the analog workflow (film, paper) to the digital (filmless, paperless) is main purpose of this workflow. Also it is focused on accelerating productivity for the radiology department and specialty practices, imaging centers, clinics, and hospitals. Paperless workflow will allow manager to reduce administration expenses such as paper, ink, and faxing. The number of employees who currently support a paper environment can drop dramatically after implementation of the new paperless workflow. New workflow can help healthcare organizations to reduce their cost and improve efficiencies.

### FIELD OF THE INVENTION

The present invention generally relates to the management system in radiology department. The present invention more specifically relates to a quality of processing system, such as, managing the workflow, delivering imaging and information services to the customers. These systems are also financially feasible for many healthcare practices, primarily because of the goals achieved through increased efficiency and improved patient care.

### BACKGROUND OF THE INVENTION

Medical images generated by an imaging modality, such as X-rays, CAT (computerized axial tomography) scans, MRI's (magnetic resonance imaging), US (ultrasound), and mammographic studies are commonly digitized to facilitate reading by doctors. In use, hospitals and other healthcare providers commonly use systems to capture and digitize the medical images. The medical images are typically transmitted from the modality to a remote image server such as a picture archiving and communications system (PACS). This transmission may occur over a network, such as an intranet or the Internet.

Additionally, the administrator's staff may also transmit medical patient record corresponding to the images of the radiologist information system (RIS) using a scanner. Patient records and orders are used to request a doctor to interpret, or read the images and return a diagnostic report. This information may also contain additional information related to the image or the patient, such as a patient identifier, the procedure type associated with the image, patient demographic information, and a hospital identifier. Thus, orders and patient information may be submitted by hospitals and healthcare providers to identify the patient and instruct the radiologist to provide information for a specific medical condition.

### BRIEF SUMMARY OF THE INVENTION

One of the aspects of the present invention includes the management system configuration in the radiology department. Using a scanner scheduling, registration and technologist will scan all papers in the department into the electronic medical record. After a technologist finishes a procedure (CT, XR, MRI, US, and Mammo) with a patient, the images and papers will send to the RIS system, then the radiologist, using PACS and EPIC systems, can easily access the patient's image and patient chart because everything is available in the RIS. This system has the advantage that the radiologist can be anywhere; he/she does not need to wait for when the technologist will bring a patient's paper or chart. As a result, the radiologist can have a flexible schedule not only work at the hospital or imaging center, but also work remotely. It will cut waiting time between the technologist and the radiologist. Then the transcriptionist will transcribe a report and send it back to the radiologist for a final signature. In couple of hours, the patient's result will be available in the system for referring doctors to quickly access the report and images. The time saving in this workflow is very huge and efficient.

Another invention included in this workflow is the responsibility of the IT staff (Claim 11). Current workflow doesn't allow to quickly solve the problem if one appears. To implement a new workflow will require adding some new duties for IT staff. Hourly monitoring of all the exams in the department can reduce medical errors. Mismatching of patient images can easily be determined because IT team will have access to both systems: EPIC and PACS. If any mismatch appears in the system, this workflow allow quickly identify them.

### BRIEF DESCRIPTION OF THE DRAWINGS

The foregoing and other features, aspects, and advantages of the present invention are described in detail below. The drawings comprise the following figures in which:

FIG. 1. is a current workflow management system in the radiology department

FIG. 2. is a new paperless workflow management system where the radiology department reduce amount of paper using a desktop scanner.

FIG. 3. is a new IT responsibility where IT staff can monitor and track all exams in the department and if any problems appear in the system, PACS/ EPIC applications allow them to quickly identify them and correct them. FIG. 2 and FIG. 3 are connected through network.

### DETAILED DESCRIPTION OF THE INVENTION

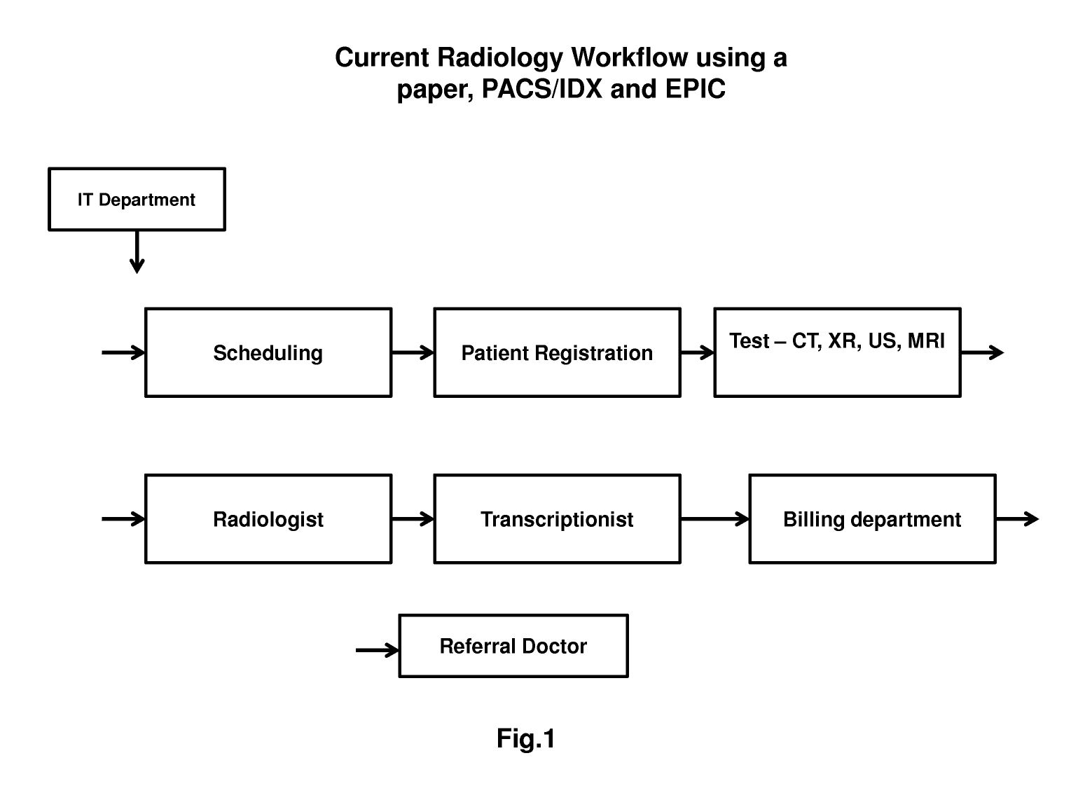

Today, many health care organizations are using the workflow on FIG. 1. In this workflow, a patient's document (chart, insurance, doctor's referral, ID, patient's evaluation sheet) and previous films are handed from one department to another. This workflow has many disadvantages such as paper can easily get lost in the department, a delay of a patient's document to the radiologists can delay a result, after testing film, can be located at the wrong place, radiologist have the problem of scanning the medical record number into the system because printer's ink does not print the barcode clearly on a paper, during the busy time, technologists have a problem after testing to deliver a patient's chart to the radiologist to read because they need to get the next patient, especially if the reading room are located far from them, and radiologists have a problem with an emergency patient because the ER already made patient's test and send it to the PACS but they don't receive a paper to start dictating from ER. The IT department doesn't have the ability to find and fix a problem during the next 24 hours. In most cases, all problems appear in the next 72 hours. That can be very inefficient way to manage patient care and many nurses; referral doctors have a problem with misspelling patient names, mismatching the medical record number of patients, and scanning the images under a wrong patient. As a result, the manager receives a huge number of complaints about radiologists, technologists or other staff in the radiology department. Basically, it's hard to find who made a mistake or error. It's a workflow fault that doesn't allow for fixing a problem simultaneously during the process. All these delay have a huge negative impact on the patient care and the department efficiency continues to decline.

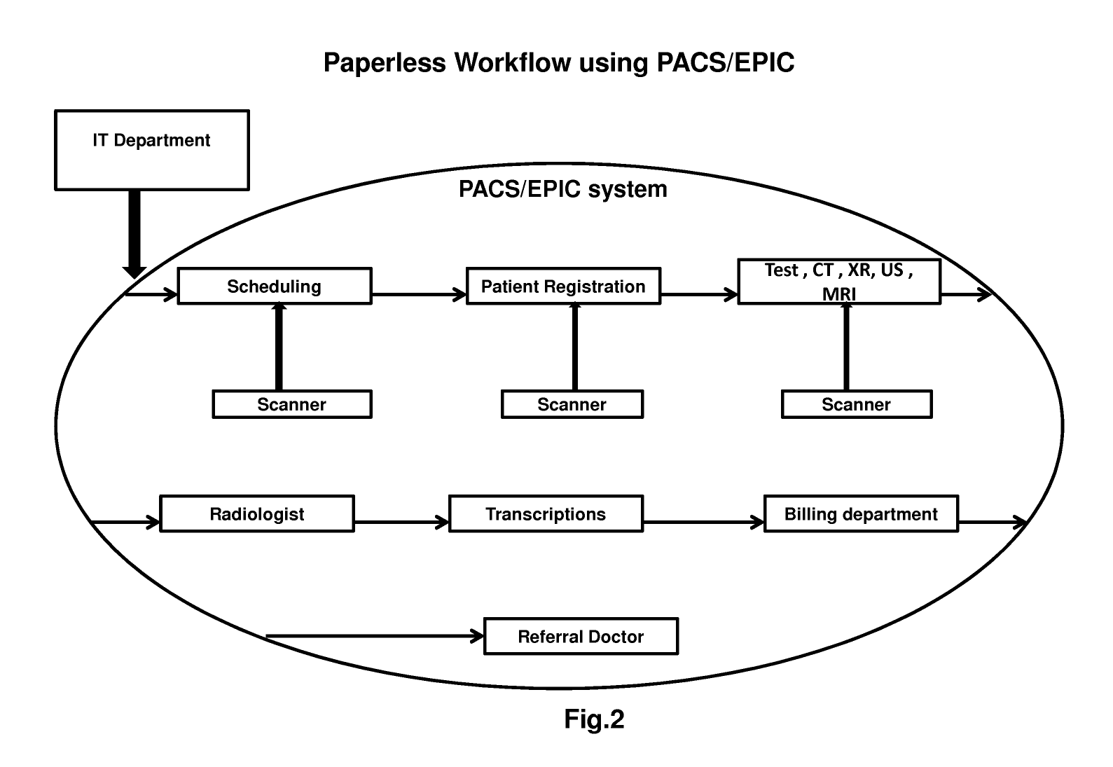

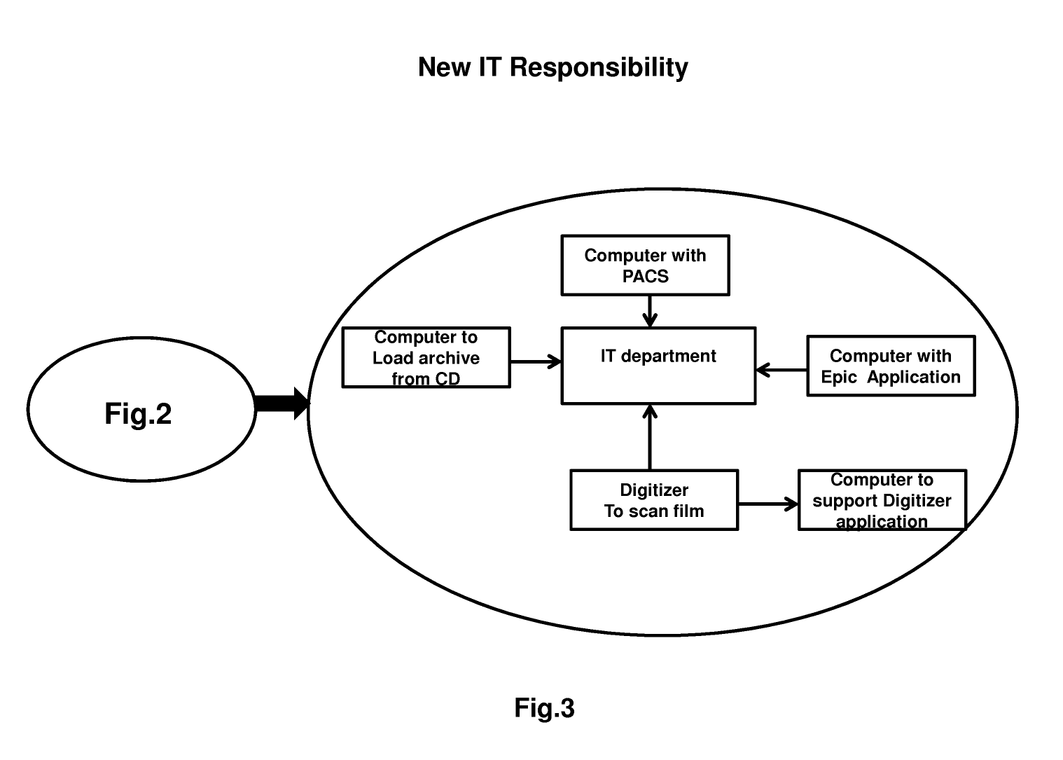

All these disadvantages bring up the idea to implement a new workflow process shown in FIG. 2. and FIG. 3.

In FIG. 2, scheduling, registration, and technologists have to connect their computers with a desktop scanner that will allow them to scan patient's paper into the EMR system (Claim 8). Then the radiologist can easily access the patient EMR and PACS system. As a result, the transcriptionist will get results very quickly and referral doctors also can access both systems as well. To set up these methods will make the workflow more efficient. For IT staff, monitoring all the exams using the Epic Radiant module during the day becomes much simpler and it is easier to fix any errors during the process, such as the misspelling of patients' names, mismatches of the medical record number of patients, or scanning the images under a wrong patient because this workflow allow it to see the whole movement of the patient in the department. Time to find and fix a problem will drop from previous paper workflow to the new one by approximately a couple of hours. As a result, fewer complaints will come to the department and the efficiency of patient care will increase.

In FIG. 3. it shows a combination of the administration part and the diagnostic part together using a new implementation of IT responsibility. It shows that the IT team has more duties to control and monitor for the exams in paperless workflow. Using all applications in the department, such as PACS and EPIC, IT staff can easily monitor all exams in the department and use a digitizer to digitize necessary film into the PACS. Today the digital mammography is a more effective way to screen for breast cancer, so many organizations are willing to move from the film mammography to the digital.

Implementation of the new paperless workflow has a huge impact for a healthcare organization. The lack of integration between clinical applications and PACS systems will disappear. This paperless process will improve workflow, decrease interruptions to radiologists, decreased delays to patients, and decreased frustration for ordering physicians. Patient and ordering clinician satisfaction will remain high and support staff has enthusiastically embraced the process due to its simplicity and reduction of rework.

What is claimed is:

1. Using a digitizer all films from different modalities CT, MRI, US, NM, XR, and mammographic studies can transfer from the analog system to the digital system. These studies transfer into the network system through the picture archive communication system (PACS), which electronically captures, transmits, displays, and saves images into digital archives for use at any given time

2. The method of claim 1, wherein the images can transfer internally within departments and externally to other facilities such as the office of the patient's doctor.

3. The method of claim 1, wherein the process allows for arguably clearer and easier to read images allowing the patient a faster evaluation and diagnosis.

4. The method of claim 1, wherein the process is simplified and access to results of the patient record goes electronically.

5. The method of claim 1, wherein the filmless workflow with PACS allows immediate access to imaging studies by attending physicians, consultants, and radiologists—simultaneously and the patient images can be available at the patient's bedside, in the physician's office, or even at the physician's home.

6. The method of claim 1, wherein the amount of time needed to track down imaging studies greatly reduces.

7. The method of claim 1, wherein the images lost can be eliminated and patient care is improved by avoiding the well-known problems of misplaced films in emergency and critical care settings.

8. At the same time administrator's staff, using a scanner can turn paper document into the digital files effortlessly with top-quality document scanners; to scan all patients' charts, and orders into the electronic medical record.

9. The method of claim 8, further allow for departments to cut administration cost because paper charts are costly, hard to keep track of, impossible to get reports immediately, take up space, and paper charts are rarely up to date, to fax it to the different locations.

10. The method of claim 8, further allow for departments to reduce the number of employees. Every department spends a lot of money to pay employees to find the charts, to put them away, to copy, to archive them, and to keep staff to fax some papers to certain location within organization.

11. New paperless workflow requires working closely with IT department. To implement filmlessness, paperless systems at the radiology department will bring a new responsibility for IT team.

12. The method of claim 11, where the IT staff will provide monitoring for all exams of the department using PACS and EPIC systems.

13. The method of claim 11, further allow to quickly correct medical errors in the systems, to reduce interruptions between the technologist and radiologist, to minimize a compliance and to increase efficiency within organization.

14. The method of claim 11, further allow for the billing department not miss any procedures order to charge patient testing correctly.
